(19) United States
(12) Patent Application Publication
(10) Pub. No.: US 2025/0309231 A1
(43) Pub. Date: Oct. 2, 2025

(54) METHOD FOR RECOVERING PERFORMANCE OF LITHIUM-ION SECONDARY BATTERY

(71) Applicant: HONDA MOTOR CO., LTD., Tokyo (JP)

(72) Inventors: Sae Ishihara, Wako-shi (JP); Shuichi Kazuno, Wako-shi (JP); Taichiro Sato, Wako-shi (JP); Tomohiro Inoue, Wako-shi (JP); Kenta Urata, Wako-shi (JP); Takeshi Muro, Wako-shi (JP); Takashi Higono, Wako-shi (JP)

(21) Appl. No.: 19/066,211

(22) Filed: Feb. 28, 2025

(30) Foreign Application Priority Data
Mar. 29, 2024 (JP) 2024-057915

(51) Int. Cl. H01M 4/04; H01M 10/0525; H01M 10/0568; H01M 10/44

(52) U.S. Cl. CPC H01M 4/0459; H01M 10/0525; H01M 10/0568; H01M 10/44; H01M 2300/0025

(57) ABSTRACT

A method for recovering performance of a lithium-ion secondary battery by doping lithium ions into a positive electrode that is in the lithium-ion secondary battery having a decreased capacity, in which the doping of the lithium ions is performed in an electrolytic solution by discharge using a lithium electrode as a counter electrode, and the discharge is performed up to a predetermined potential VE (V).

### CROSS-REFERENCE TO RELATED APPLICATION

Priority is claimed on Japanese Patent Application No. 2024-057915, filed Mar. 29, 2024, the content of which is incorporated herein by reference.

### BACKGROUND OF THE INVENTION

### Field of the Invention

The present invention relates to a method for recovering the performance of a lithium-ion secondary battery.

### Description of Related Art

Recently, from the viewpoint of climate-related disasters, an interest in electric vehicles has been rising for CO₂ reduction, and studies on the use of lithium-ion batteries for automotive applications have been in progress.

Usually, the performance of a lithium-ion battery deteriorates as the lithium-ion battery is repeatedly charged and discharged. Various proposals have been made regarding a method for recovering the performance of a lithium-ion battery.

For example, PCT International Publication No. WO 2022/034717 discloses a device for recovering the capacity of a secondary battery including a capacity estimation portion that calculates an estimated capacity, which is an estimated value of the capacity of the secondary battery, a capacity recovery process portion that performs a capacity recovery process of the secondary battery by migrating reaction species from a capacity recovery electrode to a positive electrode or a negative electrode, and an electricity quantity calculation portion that calculates the quantity of electricity conducted, which is a quantity of electricity that is supposed to be conducted to the capacity recovery electrode, in which the capacity recovery process portion includes an electricity quantity monitoring portion that determines the quantity of electricity flowing to the positive electrode or the negative electrode from the capacity recovery electrode or a voltage monitoring portion that monitors the voltage between the capacity recovery electrode and the positive electrode or the negative electrode.

Japanese Unexamined Patent Application, First Publication No. 2012-022969 discloses a method for regenerating an electrode of a lithium-ion battery in which an electrode of a used lithium-ion battery is washed with a polar solvent to wash away a Li-containing degradation substance adhering to the surfaces of active material particles, which is a main factor for the capacity degradation of the electrode, the electrode is sufficiently dried to volatilize the washing solvent, and an electrolytic solution is reinjected into the battery with the dried electrode.

Japanese Unexamined Patent Application, First Publication No. 2021-151169 discloses a secondary battery device capable of preventing the loss of a potential measurement function of a third electrode in a secondary battery in which the third electrode for measuring the potentials of a positive electrode and a negative electrode also plays a role of a supply source of lithium ions to the positive electrode and the negative electrode.

Japanese Unexamined Patent Application, First Publication No. 2017-091923 discloses a method for recovering the capacity of a lithium-ion secondary battery using a third electrode, in which a potential difference (V) between a positive electrode and the third electrode is measured, and a capacity recovery process is stopped on the condition that the measured potential difference reaches a predetermined stop reference value. In this context, the positive electrode and the third electrode are electrically conducted in advance using a reference lithium-ion secondary battery having the same configuration as the lithium-ion secondary battery that is the capacity recovery target, the potential difference (V) between the positive electrode and the third electrode, which decreases with the lapse of time from the beginning of the electrical conduction, is monitored, a fluctuation in the potential difference along with the lapse of the time (hr) is determined from the monitored potential difference, a potential difference rapid decrease period, a potential difference fluctuation transition period, and a potential difference stable decrease period are determined from the potential difference fluctuation, and a potential difference that corresponds to the potential difference fluctuation transition period is employed as the stop reference value.

### SUMMARY OF THE INVENTION

None of Patent Documents 1 to 4 disclose means for appropriately controlling the degree of recovery.

An aspect of the present invention has been made in consideration of what has been described above, and an object of the present invention is to provide a method for recovering the performance of a lithium-ion secondary battery, which is capable of appropriately recovering the performance of a lithium-ion secondary battery.

In order to achieve the above-described object, the present invention proposes the following means.

[1] A method for recovering performance of a lithium-ion secondary battery by doping lithium ions into a positive electrode that is in the lithium-ion secondary battery having a decreased capacity,

in which the doping of the lithium ions is performed in an electrolytic solution by discharge using a lithium electrode as a counter electrode, and the discharge is performed up to a potential VE (V) represented by a formula 1 below:

$$0.90 \times VB \leq VE \leq 1.10 \times VB , \qquad Formula 1$$

wherein VB is y when x in the following function represented by a formula 2 below is zero:

$$y = f ( x ) , \qquad Formula 2$$

wherein x is a capacity of the positive electrode that is in the lithium-ion secondary battery in an initial state, and y is a potential of the positive electrode that is in the lithium-ion secondary battery in the initial state.

[2] The method according to [1], which is performed non-destructively with respect to the positive electrode.

[3] The method according to [1] or [2], in which the discharge is performed under a constant current/constant voltage condition.

[4] The method according to any one of [1] to [3], in which a differential capacity curve in the lithium-ion secondary battery having a decreased capacity and a differential capacity curve of the lithium-ion secondary battery in the initial state are compared to determine a mode of a capacity decrease, and whether or not to perform the discharge is determined based on the determined mode of capacity decrease.

[5] The method according to [4], including:
comparing a differential capacity curve 1 in the lithium-ion secondary battery having a decreased capacity and a differential capacity curve 2 of the lithium-ion secondary battery in the initial state to thereby determine the mode of the capacity decrease to be any of (1) structural degradation of a positive electrode active material that is in the positive electrode, (2) a capacity decrease of a negative electrode, and (3) a discrepancy between a positive electrode potential and a negative electrode potential, based on which whether or not to perform the discharge based on a determination result is determined,
in which the differential capacity curve 1 is a differential capacity curve that is obtained by differentiating a formula 3 below at x1, and the differential capacity curve 2 is a differential capacity curve that is obtained by differentiating a formula 4 below at x2:

$$y 1 = f ( x 1 ) , \qquad Formula 3$$

wherein x1 is a capacity of the lithium-ion secondary battery having a decreased capacity, and y1 is a potential of the lithium-ion secondary battery having a decreased capacity, and

$$y 2 = f ( x 2 ) , \qquad Formula 4$$

wherein x2 is a capacity of the lithium-ion secondary battery in the initial state, and y2 is a potential of the lithium-ion secondary battery in the initial state.

[6] The method according to [5], in which the mode is categorized into (1), (2), and (3) based on criteria described below:
mode (1): a distance between peaks derived from the positive electrode differs between the differential capacity curve 1 and the differential capacity curve 2,
mode (2): a distance between peaks derived from a negative electrode differs between the differential capacity curve 1 and the differential capacity curve 2, and
mode (3): a position of the peak derived from the positive electrode or a position of the peak derived from the negative electrode differs between the differential capacity curve 1 and the differential capacity curve 2.

[7] The method according to [4], in which the discharge is performed a capacity decrease is found to have occurred due to the mode (2) or the mode (3) and no capacity decrease is found to have occurred due to the mode (1).

[8] A method for recovering performance of a lithium-ion secondary battery by doping lithium ions into a positive electrode that is in the lithium-ion secondary battery having a decreased capacity,

in which the doping of the lithium ions is performed in an electrolytic solution by discharge using a lithium electrode as a counter electrode,

the doping of the lithium ions is controlled based on a potential of the positive electrode upon conduction of electricity, and

a potential of the positive electrode upon completion of the conduction of electricity is set based on a potential of the positive electrode in an initial state of the lithium-ion secondary battery.

[9] The method according to [8], in which the potential of the positive electrode upon the completion of the conduction of electricity is set based on a potential of the positive electrode in a state where a state of charge is a predetermined value or less in the lithium-ion secondary battery in the initial state.

[10] The method according to [9], in which the potential of the positive electrode upon the completion of the conduction of electricity is set based on a potential of the positive electrode in a state where the state of charge is 0% in the lithium-ion secondary battery in the initial state.

[11] The method for recovering performance of a lithium-ion secondary battery according to any one of [8] to [10], in which the potential of the positive electrode upon the completion of electricity is set based on an open circuit potential of the positive electrode of the lithium-ion secondary battery in the initial state.

It is possible to provide a method for recovering the performance of a lithium-ion secondary battery, which is capable of appropriately recovering the performance of a lithium-ion secondary battery.

### BRIEF DESCRIPTION OF THE DRAWINGS

FIG. 1 shows graphs describing causes of capacity decreases of a lithium-ion secondary battery.

FIG. 2 shows a view for describing a configuration at the time of performing discharge in one embodiment of a performance recovery method of the present invention.

FIG. 3 shows a view for describing one example of a monopolar dV/dQ curve of each of a positive electrode and a negative electrode in an initial state of the lithium-ion secondary battery.

FIG. 4 shows a view for describing one example of an actual measurement curve and a fitted curve of a dV/dQ curve of the lithium-ion secondary battery.

FIG. 5 shows a view for describing comparison between a dV/dQ curve in an initial state and a dV/dQ curve in a degraded state.

FIG. 6 shows a graph illustrating a relationship between a capacity retention (%) after a recovery process of a lithium-ion secondary battery and a capacity retention (%) in a degraded state in Comparative Example 1.

FIG. 7 shows a graph for describing the recovery states of the lithium-ion secondary battery in Comparative Example 1.

FIG. 8 shows a view illustrating a flow of the performance recovery method of the present invention.

### DETAILED DESCRIPTION OF THE INVENTION

Hereinbelow, a method for recovering the performance of a lithium-ion secondary battery according to an embodiment of the present invention is described with reference to drawings.

The method of the present embodiment is a method for recovering performance of a lithium-ion secondary battery by doping lithium ions into a positive electrode that is in the lithium-ion secondary battery having a decreased capacity, in which the doping of the lithium ions is performed in an electrolytic solution by discharge using a lithium electrode as a counter electrode, and the discharge is performed up to a potential VE (V) represented by a formula 1 below.

$$0.90 \times VB \leq VE \leq 1.10 \times VB \qquad Formula 1$$

In the formula 1, VB is y when x in the following function represented by a formula 2 below is zero.

$$y = f ( x ) \qquad Formula 2$$

In the formula 2, x is a capacity of the positive electrode that is in the lithium-ion secondary battery in an initial state, and y is a potential of the positive electrode that is in the lithium-ion secondary battery in the initial state.

In this context, “initial state” means that the lithium-ion secondary battery is in an unused state or the lithium-ion secondary battery is in an undegraded state, that is, a state where the capacity of the lithium-ion secondary battery has not decreased due to a charge/discharge cycle. More specifically, the initial state is preferably a state at a point in time when formation has been completed.

In addition, the method of the present embodiment is preferably performed non-destructively without disassembling the positive electrode into components.

### (Lithium-Ion Secondary Battery)

A lithium-ion secondary battery the performance of which is recovered by the method of the present embodiment (hereinafter, also simply referred to as “battery”) is not particularly limited, and a well-known lithium-ion secondary battery can be used. The lithium-ion secondary battery is usually composed of a positive electrode, a negative electrode, and an electrolyte (an electrolytic solution or a solid electrolyte) that is disposed between the positive electrode and the negative electrode. In addition, a separation membrane (separator) may be provided between the positive electrode and the negative electrode. The positive electrode and the negative electrode each contain an active material, a binder, and a current collector. Hereinbelow, the configurations of the positive electrode and the negative electrode are described.

### “Positive Electrode”

The positive electrode contains a positive electrode active material, a positive electrode conductive agent, a positive electrode binder, and a positive electrode current collector. A layer composed of the positive electrode active material, the positive electrode conductive agent, and the positive electrode binder is regarded as a positive electrode mixture layer. The positive electrode mixture layer may be formed on one surface or both surfaces of the positive electrode current collector. The positive electrode mixture layer may contain no positive electrode conductive agent as long as the positive electrode active material is sufficiently conductive.

The positive electrode active material, which is an active material that is used in the positive electrode, is not particularly limited as long as the positive electrode active material is capable of storing and releasing Li ions. Examples of the positive electrode active material include lithium nickel oxide (for example, LiNiO₂), lithium cobalt oxides (for example. LiCoO₂), lithium nickel cobalt oxide, lithium nickel cobalt manganese oxide, LiFePO₄, LiMn₁₋ₓFeₓPO₄, LiMnPO₄, LiCoPO₄, LiNiPO₄, and the like. The positive electrode active material preferably contains one or more selected from the group consisting of manganese, nickel, and cobalt.

The positive electrode conductive agent, which is a conductive agent that is used in the positive electrode, assists the formation of a conductive path between the positive electrode active material and the positive electrode current collector. The positive electrode conductive agent is not particularly limited as long as the positive electrode conductive agent is conductive, and examples thereof include carbon black such as acetylene black, carbon nanotubes, graphite such as artificial graphite, and the like.

The positive electrode binder, which is a binder for the positive electrode active material, binds together the positive electrode active material, the positive electrode conductive agent, and the positive electrode current collector. Examples of the positive electrode binder include polyvinylidene fluoride (PVDF), polytetrafluoroethylene (PTFE), polyamide (PA), polyimide (PI), polyacrylic acids, copolymers thereof, polyamideimide (PAI), polybenzimidazole, polyethersulfone (PES), maleic anhydride-modified polypropylene, mixtures thereof, and the like. The positive electrode binder preferably contains a crystalline polymer having a melting point. The positive electrode binder is preferably a polymer containing fluorine. Examples of the polymer containing fluorine include PVDF, PTFE, and the like.

Examples of the positive electrode current collector include metal foils such as an aluminum foil, a stainless steel foil, and a nickel foil. The positive electrode current collector may have a carbon coating layer formed thereon. In addition, the positive electrode current collector may be processed into a mesh.

### “Negative Electrode”

The negative electrode contains a negative electrode active material, a negative electrode conductive agent, a negative electrode binder, and a negative electrode current collector. A layer composed of the negative electrode active material, the negative electrode conductive agent, and the negative electrode binder is regarded as a negative electrode mixture layer. The negative electrode mixture layer may be formed on one surface or both surfaces of the negative electrode current collector. The negative electrode mixture layer may contain no negative electrode conductive agent as long as the negative electrode active material is sufficiently conductive.

The negative electrode active material, which is an active material that is used in the negative electrode, is not particularly limited as long as the negative electrode active material is capable of storing and releasing Li ions. Examples of the negative electrode active material include graphite (artificial graphite and natural graphite), amorphous carbon (hard carbon), mesocarbon microbeads, carbon fibers, Si materials (silicon, Si alloys, and Si oxides), and the like.

The negative electrode conductive agent, which is a conductive agent that is used in the negative electrode, assists the formation of a conductive path between the negative electrode active material and the negative electrode current collector. The negative electrode conductive agent is not particularly limited as long as the negative electrode conductive agent is conductive, and examples thereof include carbon black such as acetylene black, carbon nanotubes, graphite such as artificial graphite, and the like.

The negative electrode binder, which is a binder for the negative electrode active material, binds together the negative electrode active material, the negative electrode conductive agent, and the negative electrode current collector. Examples of the negative electrode binder include carboxymethyl cellulose, polyvinylidene fluoride, polytetrafluoroethylene, polyacrylic acid, fluororubber, diene-based rubber such as styrene butadiene rubber, and the like. The negative electrode binder preferably contains a crystalline polymer having a melting point.

Examples of the negative electrode current collector, which is a current collector for the negative electrode, include metal foils such as a copper foil, a stainless steel foil, and a nickel foil. The negative electrode current collector may have a carbon coating layer formed thereon. In addition, the negative electrode current collector may be processed into a mesh shape.

(Step of Doping Lithium Ions into Positive Electrode)

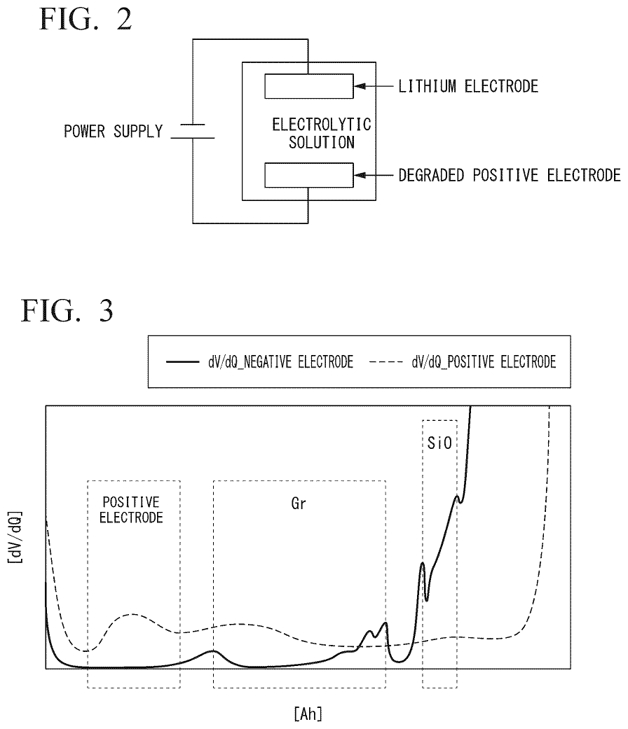

In the method of the present embodiment, the doping of lithium ions is performed in an electrolytic solution by discharge using a lithium electrode as a counter electrode. A configuration for performing the discharge is illustrated in FIG. 2. That is, as illustrated in FIG. 2, the positive electrode and the lithium electrode, as the counter electrode, are immersed in the electrolytic solution, a voltage is applied between the positive electrode and the lithium electrode to perform discharge from the lithium electrode.

The discharge is performed up to a potential VE (V) represented by a formula 1 below (hereinafter, this step will also be referred to as “recovery process” in some cases).

$$0.90 \times VB \leq VE \leq 1.10 \times VB \qquad Formula 1$$

In the formula 1, VB is y when x in the following function represented by a formula 2 below is zero.

$$y = f ( x ) \qquad Formula 2$$

In the formula 2, x is the capacity of the positive electrode that is in the lithium-ion secondary battery in the initial state, and y is the potential of the positive electrode that is in the lithium-ion secondary battery in the initial state.

### “Counter Electrode”

The lithium electrode as the counter electrode is desirably metallic lithium and can be configured in the same manner as the negative electrode.

### “Electrolytic Solution”

The electrolytic solution is not particularly limited, and solutions that are usually used as electrolytic solutions for lithium-ion secondary batteries can be used. For example, it is possible to apply aprotic organic solvents such as ethylene carbonate (EC), propylene carbonate (PC), butylene carbonate (BC), dimethyl carbonate (DMC), ethyl methyl carbonate (EMC), diethyl carbonate (DEC), methyl propyl carbonate (MPC), and ethyl propyl carbonate (EPC).

In addition, as the electrolytic solution, it is possible to apply electrolytic solutions obtained by dissolving a lithium salt, such as lithium hexafluorophosphate, lithium tetrafluoroborate, lithium perchlorate, lithium iodide, lithium chloride, lithium bromide, LiB[OCOCF₃]₄, LiB[OCOCF₂CF₃]₄, LiPF₄(CF₃)₂, LiN(SO₂CF₃)₂, or LiN(SO₂CF₂CF₃)₂, or a mixture of two or more lithium salts thereof in a solvent mixture of two or more organic compounds out of these aprotic organic solvents.

### “Potential VE (V)”

The potential VE (V) satisfies the formula 1, preferably satisfies a formula 1a below, and more preferably satisfies a formula 1b below.

$$0.95 \times VB \leq VE \leq 1.05 \times VB \qquad Formula 1 a$$

$$0.98 \times VB \leq VE \leq 1.02 \times VB \qquad Formula 1 b$$

In the formulae, VB is as defined in the formula 1.

When the discharge is performed up to the potential VE (V) that satisfies the above-described formula, it is possible to prevent the capacity after the recovery process from becoming deficient or excessive compared with the capacity in the initial state. When the capacity is excessively recovered and becomes larger than that in the initial state, the amount of Li in the positive electrode becomes excessive, and in a case where this positive electrode is incorporated into the battery again, there is a concern that Li may be deposited. From this viewpoint, the recovery rate that is represented by the proportion (%) (xd/x×100) of the capacity (xd) of the positive electrode after the completion of the doping to the capacity (x) of the positive electrode that is in the lithium-ion secondary battery in the initial state is preferably adjusted to 90 to 110%, more preferably adjusted to 95 to 102%, and substantially, most preferably 100%.

In conventional methods, even when an attempt is made to recover the capacity by an amount decreased by the use, proper control is not possible, and it is not possible to prevent the capacity after the recovery process from becoming deficient or excessive. But the present invention enables an optimal recovery state to be realized by controlling the discharge based on the potential VE (V) that satisfies the above-described formula.

x (the capacity of the positive electrode that is in the lithium-ion secondary battery in the initial state) and y (the potential of the positive electrode that is in the lithium-ion secondary battery in the initial state) in the formula 2 are preferably obtained based on the state of charge (SOC) and the open circuit potential (OCP) acquired from the positive electrode that is in a lithium-ion secondary battery having the same specifications as the lithium-ion secondary battery, which is the recovery process target.

### “Discharge Conditions”

The discharge is preferably performed under a constant current/constant voltage (CCCV) condition. More specifically, the discharge is performed under the following conditions.

The discharge is performed until a predetermined voltage (V0) is reached at a certain current value (I0), then, the control is switched to maintain the predetermined voltage (V0), and the discharge is ended at a point in time where the current value is attenuated to a predetermined value (I1).

V0: A voltage at the intercept in a capacity-voltage curve

I0: A current rate of 0.3 C or lower, which is preferably 0.1 C or lower. (A lower current rate I0 results in a higher accuracy of the recovery degree, but results in a longer the time of the discharge process. From this viewpoint, the current rate I0 is preferably 0.01 C or higher.)

I1: A current rate of ½ or less of I0, which is preferably 0.05 C or lower. (A lower current rate I1 results in a higher accuracy of the recovery degree, but results in a longer time of the discharge process. From this viewpoint, the current rate I1 is preferably 0.001 C or higher.)

In this context, a current value at which the battery rated capacity of a new product can be discharged in one hour is 1 C.

### “Specification and Classification of Capacity Degradation Modes (Causes)”

In the method for recovering the performance of a lithium-ion secondary battery of the present embodiment, it is preferable to compare a differential capacity curve 1 for the lithium-ion secondary battery having a decreased capacity and a differential capacity curve 2 for the lithium-ion secondary battery in the initial state, categorize the modes (causes) of capacity decreases into the following three modes (causes): (1) the structural degradation of the positive electrode active material that is in the positive electrode, (2) a capacity decrease of the negative electrode, and (3) a discrepancy between the positive electrode potential and the negative electrode potential, and determine whether or not to perform the discharge based on the categorization results.

In this context, the differential capacity curve 1 is a differential capacity curve that is obtained by differentiating a formula 3 below at x1, and the differential capacity curve 2 is a differential capacity curve that is obtained by differentiating a formula 4 below at x2.

$$y 1 = f ( x 1 ) \qquad Formula 3$$

In the formula 3, x1 is the capacity of the lithium-ion secondary battery having a decreased capacity, and y1 is the voltage or monopolar potential of the lithium-ion secondary battery having a decreased capacity.

$$y 2 = f ( x 2 ) \qquad Formula 4$$

In the formula 4, x2 is the capacity of the lithium-ion secondary battery in the initial state, and y2 is the voltage or monopolar potential of the lithium-ion secondary battery in the initial state.

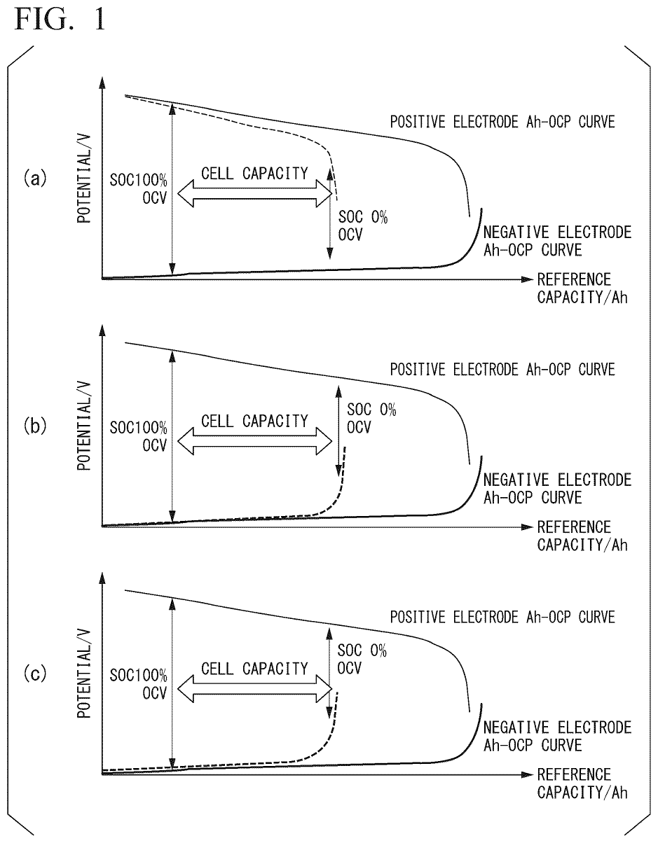

FIG. 1(a), FIG. 1(b), and FIG. 1(c) illustrate the images of capacity decreases due to the above-described causes (1), (2), and (3).

A method for acquiring the differential capacity curve 1 and the differential capacity curve 2 and a method for the mode categorization are described below.

### <Advance Preparation>

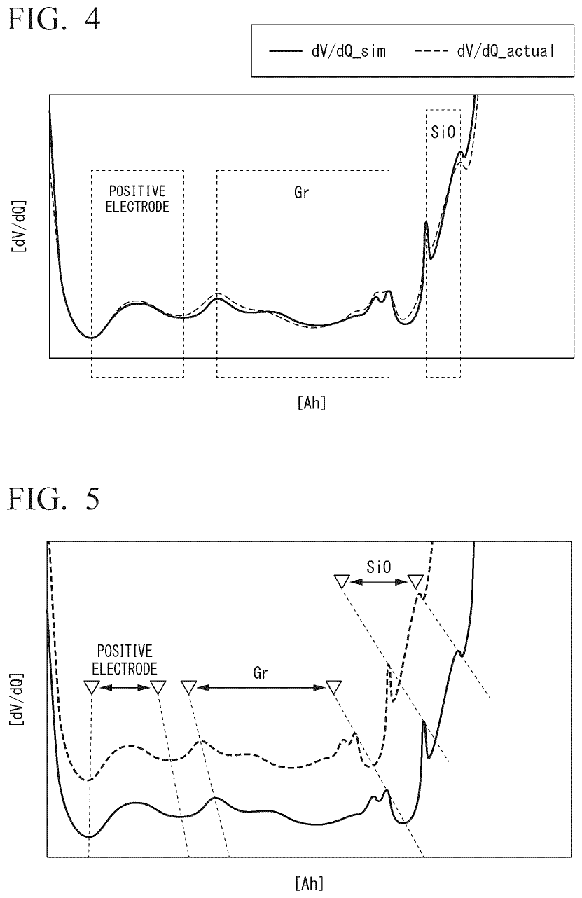

As advance preparation, for example, first, a battery having the same specifications as the lithium-ion secondary battery that becomes the target is disassembled, and monopolar data in coin cell units, that is, the respective monopolar dV/dQ curves for the positive electrode and the negative electrode in the initial state as illustrated in FIG. 3 are obtained. Furthermore, these monopolar dV/dQ curves are added together and fitted into an actual measurement curve (a curve drawn by the dotted line in FIG. 4) of the lithium-ion secondary battery as illustrated in FIG. 4. In FIG. 4, the fitted curve is indicated with the solid line. This makes it possible to attribute the individual electrode values in the actual measurement curve to the positive electrode and the negative electrode. The dV/dQ curve in the initial state of the used lithium-ion secondary battery having a decreased capacity (differential capacity curve 2) is acquired in advance as described above. In addition, the respective peak positions for the positive electrode and the negative electrode in the dV/dQ curve are determined, and the respective inter-peak distances for the positive electrode and the negative electrode in the initial state are determined.

In FIG. 3 and FIG. 4, the horizontal axes indicate the capacity (Ah) of the cell, and the vertical axes indicate the amount of the voltage changed relative to a change in the reference capacity (dV/dQ).

In this context, when a peak position can be detected at a state of charge (SOC) or charge state within a range of 5% to 95% with the full charge state being defined as 100%, differential capacity analysis becomes possible. Specifically, in the dV/dQ curve in the initial state (differential capacity curve 2), two peaks based on the positive electrode are specified, and the distance between these peaks is specified. In FIG. 3 and FIG. 4, two peaks (downward peaks) based on the positive electrode are positioned at the intersection points with the dotted line. In addition, in the dV/dQ curve in the initial state (differential capacity curve 2), two peaks based on the negative electrode are specified, and the distance between these peaks is specified. In FIG. 3 and FIG. 4, two peaks based on the negative electrode are positioned at the intersection points with the dotted line.

For example, as standards, two peaks within an SOC range of 0% to 30% (low SOC range) may be determined as the peaks for the positive electrode, two peaks within a range of 30% to 60% may be determined as the peaks for the negative electrode (graphite in the example of the present embodiment) (the intersection points with the dotted line Gr), and two peaks within an SOC range of 60% to 100% (high SOC range) may be determined as the peaks for silicon oxide (SiO) in the negative electrode (the intersection points with the dotted line SiO). What has been described above can also be determined with the fact that the peaks of the positive electrode form dents toward the negative side of dV/dQ and the peaks of the negative electrode form bumps toward the positive side of dV/dQ. Peaks derived from a material used to form an electrode are supposed to appear; however, for example, when the negative electrode does not contain SiO, no peaks derived from SiO appear.

### <After Battery Capacity Decrease>

Regarding the lithium-ion secondary battery having a capacity decreased due to use, information on the voltage and the current is continuously acquired by a charge under a low current. It is important that the current is a relatively low current. A capacity is obtained by integrating the current values over time, whereby a curve of the voltage values with respect to the capacity can be obtained. Furthermore, the voltage values are differentiated at the capacity, whereby the differential capacity curve 1 (dV/dQ curve) with respect to the capacity can be obtained.

The rate of the charge can be analyzed even when the rate is 0.2 to 0.5 C, which is usual. However, when the rate is, for example, as low as 0.02 to 0.07 C, analysis with higher accuracy is possible. In a case where the charge has progressed to a certain extent, and the voltage has become constant, the charge may be performed by decreasing the current stepwise.

As described above, the dV/dQ curve (differential capacity curve 1) can be obtained by calculating a differentiation value at a reference capacity regarding the voltage in the charge/discharge curve of the lithium-ion secondary battery. According to such a method, the fluctuation characteristics of the voltage with respect to the reference capacity of the battery, which is a degradation determination target, can be accurately recognized, and comparison of the created dV/dQ curve (differential capacity curve 1) for degradation determination with the dV/dQ curve (differential capacity curve 2) acquired in the initial state of the battery thus makes it possible to evaluate and determine how much the battery at that point in time has been degraded from the initial state.

Next, based on the obtained dV/dQ curve after a capacity decrease (differential capacity curve 1) and dV/dQ curve in the initial state (differential capacity curve 2), a first capacity decrease rate due to the degradation of the positive electrode, which is the mode (1), a second capacity decrease rate due to the degradation of the negative electrode, which is the mode (2), and the amount of capacity decreased due to the discrepancy between the positive electrode and the negative electrode, which is the mode (3), are each evaluated.

Specifically, regarding the used battery having a decreased capacity, two peaks derived from the respective electrodes are specified, and a change in the distance between these two peaks (inter-peak distance) from the initial state to a state after starting the use of the battery is evaluated. That is, the inter-peak distance for each of the positive electrode and the negative electrode is determined in the state after starting the use of the battery and compared with the above-described inter-peak distance in the initial state, thereby evaluating the change in the inter-peak distance due to the use of the battery.

### <<Determination of Mode (1) and Mode (2)>>

The dV/dQ curve in the initial state (differential capacity curve 2) and the dV/dQ curve after a capacity decrease (differential capacity curve 1) are compared with each other, and change rates of the distance between the two peaks for the positive electrode and the negative electrode are calculated. Specifically, the change rate of the distance between the two peaks for the positive electrode in the dV/dQ curve after a capacity decrease (differential capacity curve 1) relative to the dV/dQ curve in the initial state (differential capacity curve 2) is defined as the first capacity decrease rate, and the change rate of the distance between the two peaks for the negative electrode in the dV/dQ curve after a capacity decrease (differential capacity curve 1) relative to the dV/dQ curve in the initial state (differential capacity curve 2) is defined as the second capacity decrease rate. More specifically, the first capacity decrease rate and the second capacity decrease rate are calculated as described below.

$$First capacity decrease rate ( \% ) = ( positive electrode ‐ derived inter ‐ peak distance in differential capacity curve 2 - positive electrode ‐ derived inter ‐ peak distance in differential capacity curve 1 ) / positive electrode ‐ derived inter ‐ peak distance in differential capacity curve 2 \times 100$$

$$Second capacity decrease rate ( \% ) = ( negative electrode ‐ derived inter ‐ peak distance in differential capacity curve 2 - negative electrode ‐ derived inter ‐ peak distance in differential capacity curve 1 ) / negative electrode ‐ derived inter ‐ peak distance in differential capacity curve 2 \times 100$$

FIG. 5 illustrates the comparison between the dV/dQ curve of the lithium-ion secondary battery in the initial state (differential capacity curve 2) and the dV/dQ curve of the lithium-ion secondary battery having a decreased capacity (differential capacity curve 1). In FIG. 5, the solid line indicates the differential capacity curve 2 in the initial state, and the dotted line indicates the differential capacity curve 1 after a capacity decrease. In addition, the differential capacity curve 1 after a capacity decrease is shifted along the vertical axis in order to avoid overlapping. As illustrated in FIG. 5, when the differential capacity curve 2 in the initial state and the differential capacity curve 1 after a capacity decrease are compared with each other, it is found that the distance between the two peaks for each of the positive electrode and the negative electrode has changed.

Based on the first capacity decrease rate and the second capacity decrease rate, the presence or absence of capacity decreases due to the mode (1) and the mode (2) is determined. Specifically, the presence or absence is preferably determined based on the following reference.

Mode (1): The distance between the peaks derived from the positive electrode differs between the differential capacity curve 1 and the differential capacity curve 2. Specifically, in a case where the first capacity decrease rate is 10% or more and preferably 5% or more, the inter-peak distance is determined to differ, and it is determined that a capacity decrease due to the mode (1) has occurred.

Mode (2): The distance between of the peaks derived from the negative electrode differs between the differential capacity curve 1 and the differential capacity curve 2. Specifically, in a case where the second capacity decrease rate is 10% or more and preferably 5% or more, the inter-peak distance is determined to differ, and it is determined that a capacity decrease due to the mode (2) has occurred.

In the case of a battery from which a capacity decreased due to the mode (1) is recognized, a significant capacity recovery effect by the method of the present embodiment cannot be expected, the battery is preferably not considered as a process target of the method of the present embodiment. In addition, in a case where a capacity decrease seems to occur due to the generation of cracks in positive electrode active material particles according to the degradation analysis (for example, analysis with SEM) of a positive electrode active material, similarly, the battery is preferably not considered as a process target of the method of the present embodiment for the same reason.

### <<Determination of Mode (3)>>

The mode (3) is based on the shift amount of the dV/dQ curve after a capacity decrease (differential capacity curve 1) relative to the dV/dQ curve in the initial state (differential capacity curve 2). For the shift amount of the dV/dQ curve after a capacity decrease (differential capacity curve 1) relative to the dV/dQ curve in the initial state (differential capacity curve 2), a decrease in the amount of Li that participates in the charge and discharge due to the deposition of a negative electrode film containing Li caused by a side reaction on the surface of the active material is determined to be a main cause. For example, the proportion of a shift of the central point between the two peaks based on the negative electrode is regarded as the capacity decrease rate (%) due to the discrepancy between the positive electrode potential and the negative electrode potential.

Based on the capacity decrease rate, the presence or absence of a capacity decreases due to the cause (3) is determined. Specifically, the presence or absence is preferably determined based on the following criteria.

Mode (3): The positions of the peak derived from the negative electrode differ between the differential capacity curve 1 and the differential capacity curve 2. Specifically, in a case where the capacity decrease rate is 10% or more and preferably 5% or more, it is determined that a capacity decrease due to the mode (3) has occurred.

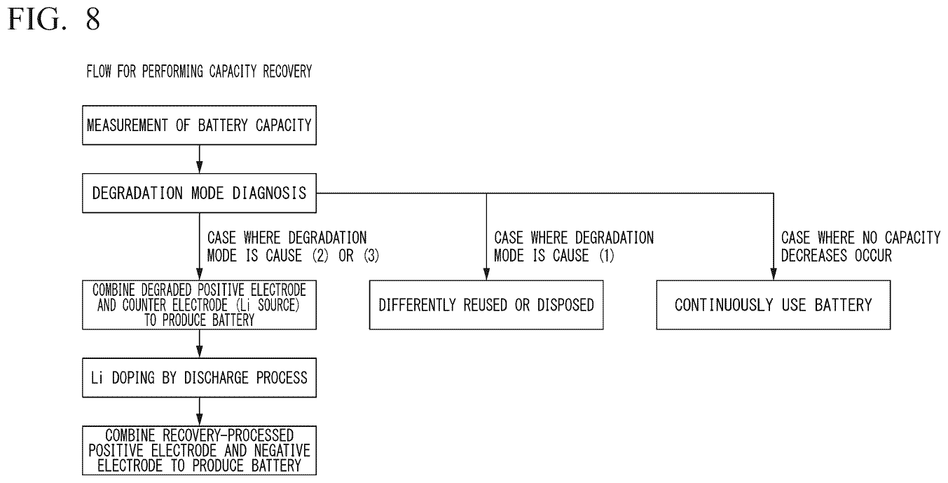

FIG. 8 illustrates one example of a flow in a case where the performance recovery method of the present invention is performed or not performed after a degradation mode diagnosis (the identification and categorization of the capacity degradation mode). Hereinbelow, this flow is specifically described.

First, the capacity of a battery is measured, and a degradation mode diagnosis is then performed. In a case where the degradation mode is the mode (2) or (3), the degraded electrode and a lithium electrode, which is a counter electrode, are combined together to produce a battery, and lithium ions are doped into the positive electrode by the discharge process. In addition, the positive electrode on which the discharge process has been performed and a negative electrode are combined together to produce a battery.

In the degradation mode diagnosis, in a case where the degradation mode is the mode (1), the battery is reused in a manner other than the regeneration of the battery by the recovery process or disposed of.

In addition, in a case where the occurrence of a capacity decreases has not been found in the degradation mode diagnosis, the battery is continuously used.

In another embodiment of the present invention, provided is a method for recovering performance of a lithium-ion secondary battery by doping lithium ions into a positive electrode that is in the lithium-ion secondary battery having a decreased capacity, in which

the doping of the lithium ions is performed in an electrolytic solution by discharge using a lithium electrode as a counter electrode,

the doping of the lithium ions is controlled based on the potential of the positive electrode upon conduction of electricity, and

the potential of the positive electrode upon completion of the conduction of electricity is set based on the potential of the positive electrode in an initial state of the lithium-ion secondary battery.

In this context, the potential of the positive electrode upon the completion of the conduction of electricity is preferably set based on the potential of the positive electrode in a state where the state of charge is a predetermined value or less in the initial state of the lithium-ion secondary battery, more preferably set based on the potential of the positive electrode in a state where the state of charge is 0% in the initial state of the lithium-ion secondary battery, and still more preferably set based on the open circuit potential of the positive electrode in the initial state of the lithium-ion secondary battery.

### Action and Effect

The above-described method for recovering performance of a lithium-ion secondary battery of the present embodiment exhibits the following effects.

It is possible to uniquely define a capacity recovery amount at a positive electrode potential regardless of the internal resistance state of the battery or the charge state at a point in time of disassembly and to appropriately recover the performance.

An arbitrary potential range can be used by acquiring, in advance, negative electrode potential data at a point in time of the completion of formation and accordingly adjusting the potential range of the positive electrode.

No special device for capacity recovery is required.

The internal structure of the battery is not different from those of usual batteries, and there is thus no contradiction of the battery performance in the initial state.

The use of charge data during connection to a battery return device (so-called battery exchanger: BEX) allows the battery to be collected and subjected to recovery process at a desired timing.

It is possible to determine a recovery method to be applied at the time of recycling the positive electrode before the secondary use of the battery on a real-time basis by predicting or detecting a cause of a capacity decrease (degradation) and the degree of the degradation.

The technical scope of the present invention is not limited to the embodiment, and it is possible to add a variety of changes within the scope of the gist of the present invention. Additionally, it is possible to appropriately substitute a component in the embodiment with a well-known component within the scope of the gist of the present invention.

### EXAMPLES

Hereinafter, the present invention will be described in more detail using examples, but the present invention is not limited to the following examples.

### Example 1

### (Used Lithium-Ion Secondary Battery)

A lithium-ion secondary battery composed of a ternary positive electrode active material was used. The potential (y) of a positive electrode of this battery was approximately 3.6 V. Therefore, the potential VE according to the formula 1 is 3.24 to 3.96 V.

### (Production of Degraded Sample Having Decreased Capacity)

The lithium-ion secondary battery was subjected to a charge/discharge test, which is described below.

The lithium-ion secondary battery was put into a thermostatic chamber at 45° C., and 1000 cycles of a charge and a discharge were repeated at a current value of 0.3 C relative to the rated capacity.

Therefore, a sample having a decreased capacity (degraded) was obtained.

The state of health (SOH: capacity retention) of the obtained degraded sample 1 was 89%.

In addition, a differential capacity curve 1 was obtained regarding this degraded sample 1 and compared with a differential capacity curve 2 of the lithium-ion secondary battery in the initial state, and consequently, it was found that a discrepancy in the negative electrode potential occurred, and the mode (cause) of the capacity decrease was specified as the mode (3) (a capacity decrease due to a potential discrepancy).

### (Electrolytic Solution)

For an electrolytic solution, LiPF₆ was used as a salt, and an aprotic solvent containing DMC was used.

### (Counter Electrode)

As a counter electrode, metallic lithium was used.

### (Discharge Test)

On the degraded sample 1, based on the potential VE according to the formula 1, a discharge (Li doping process) was performed in a constant current/constant voltage (CCCV) manner at 0.1 C and 3.6 V until the positive electrode potential reached up to 3.6 V. The positive electrode potential was monitored on a charge/discharge device, and the temperature was set to 25° C. As a result, the SOH was returned up to 97%.

### Comparative Example 1

The same operation as in Example 1 was performed except that a degraded sample 2 having a SOH of 80% and a degraded sample 3 having a SOH of 93% were produced by changing the production conditions of the degraded sample 1, and a discharge (Li doping process) was performed until the positive electrode potential reached up to 3 V.

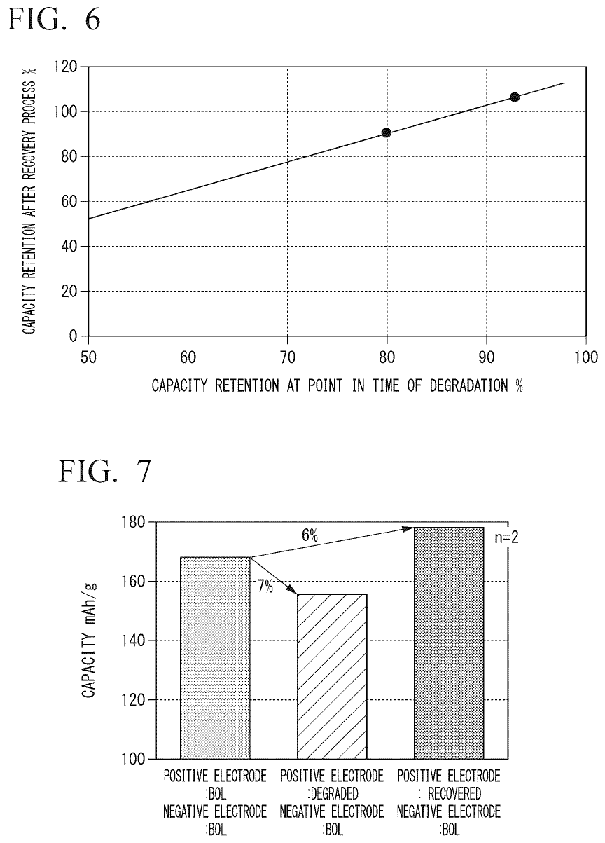

As a result, the SOH of the degraded sample 2 was recovered up to 93%, and the SOH of the degraded sample 3 was recovered up to 106%. A relationship between the SOHs of these degraded samples and the SOHs after the recovery processes is illustrated in FIG. 6. In addition, the transition of the capacity change from the initial state (BOL) is illustrated in FIG. 7. (In FIG. 7, “n=2” means that the number of the samples was two, the same test was performed twice, and the average value thereof was illustrated with a graph.)

From these results, it is found that, when a positive electrode potential not satisfying the formula 1 is taken, the capacity after the recovery process becomes excessive in some cases. When the capacity is excessively recovered and becomes larger than that in the initial state, the amount of Li in the positive electrode becomes excessive, and in a case where this positive electrode is incorporated into a battery again, there is a concern of the deposition of Li.

What is claimed is:

1. A method for recovering performance of a lithium-ion secondary battery by doping lithium ions into a positive electrode that is in the lithium-ion secondary battery having a decreased capacity,
wherein the doping of the lithium ions is performed in an electrolytic solution by discharge using a lithium electrode as a counter electrode, and the discharge is performed up to a potential VE (V) represented by formula 1 below:
$$0.90 \times VB \leq VE \leq 1.10 \times VB , \qquad Formula 1$$
wherein VB is y when x in a function represented by formula 2 below is zero:
$$y = f ( x ) , \qquad Formula 2$$
wherein x is a capacity of the positive electrode that is in the lithium-ion secondary battery in an initial state, and y is a potential of the positive electrode that is in the lithium-ion secondary battery in the initial state.

2. The method according to claim 1, which is performed non-destructively with respect to the positive electrode.

3. The method according to claim 1, wherein the discharge is performed under a constant current/constant voltage condition.

4. The method according to claim 1, wherein a differential capacity curve in the lithium-ion secondary battery having a decreased capacity and a differential capacity curve of the lithium-ion secondary battery in the initial state are compared to thereby determine a mode of capacity decrease, and
whether or not to perform the discharge is determined based on the determined mode of capacity decrease.

5. The method according to claim 4, comprising:
comparing a differential capacity curve 1 in the lithium-ion secondary battery having a decreased capacity and a differential capacity curve 2 of the lithium-ion secondary battery in the initial state to thereby determine the mode of capacity decrease to be any of (1) structural degradation of a positive electrode active material that is in the positive electrode, (2) a capacity decrease of a negative electrode, and (3) a discrepancy between a positive electrode potential and a negative electrode potential, based on which whether or not to perform the discharge is determined,
wherein the differential capacity curve 1 is a differential capacity curve that is obtained by differentiating a formula 3 below at x1, and the differential capacity curve 2 is a differential capacity curve that is obtained by differentiating a formula 4 below at x2:
$$y 1 = f ( x 1 ) , \qquad Formula 3$$
wherein x1 is a capacity of the lithium-ion secondary battery having a decreased capacity, and y1 is a potential of the lithium-ion secondary battery having a decreased capacity, and
$$y 2 = f ( x 2 ) , \qquad Formula 4$$
wherein x2 is a capacity of the lithium-ion secondary battery in the initial state, and y2 is a potential of the lithium-ion secondary battery in the initial state.

6. The method according to claim 5, wherein the mode is categorized into (1), (2), and (3) based on criteria described below:
mode (1): a distance between peaks derived from the positive electrode differs between the differential capacity curve 1 and the differential capacity curve 2,
mode (2): a distance between peaks derived from a negative electrode differs between the differential capacity curve 1 and the differential capacity curve 2, and
mode (3): a position of the peak derived from the positive electrode or a position of the peak derived from the negative electrode differs between the differential capacity curve 1 and the differential capacity curve 2.

7. The method according to claim 5, wherein the discharge is performed when a capacity decrease is found to have occurred due to the mode (2) or the mode (3) and no capacity decrease is found to have occurred due to the mode (1).

8. A method for recovering performance of a lithium-ion secondary battery by doping lithium ions into a positive electrode that is in the lithium-ion secondary battery having a decreased capacity,
wherein the doping of the lithium ions is performed in an electrolytic solution by discharge using a lithium electrode as a counter electrode,
the doping of the lithium ions is controlled based on a potential of the positive electrode upon conduction of electricity, and
a potential of the positive electrode upon completion of the conduction of electricity is set based on a potential of the positive electrode in an initial state of the lithium-ion secondary battery.

9. The method according to claim 8, wherein the potential of the positive electrode upon the completion of the conduction of electricity is set based on a potential of the positive electrode in a state where a state of charge is a predetermined value or less in the lithium-ion secondary battery in the initial state.

10. The method according to claim 9, wherein the potential of the positive electrode upon the completion of the conduction of electricity is set based on a potential of the positive electrode in a state where the state of charge is 0% in the lithium-ion secondary battery in the initial state.

11. The method according to claim 8, wherein the potential of the positive electrode upon the completion of electricity is set based on an open circuit potential of the positive electrode of the lithium-ion secondary battery in the initial state.

12. The method according to claim 9, wherein the potential of the positive electrode upon the completion of electricity is set based on an open circuit potential of the positive electrode of the lithium-ion secondary battery in the initial state.

13. The method according to claim 10, wherein the potential of the positive electrode upon the completion of electricity is set based on an open circuit potential of the positive electrode of the lithium-ion secondary battery in the initial state.
